(19) United States
(12) Patent Application Publication
(10) Pub. No.: US 2020/0094401 A1
(43) Pub. Date: Mar. 26, 2020

(54) SYSTEM AND METHOD FOR AUTOMATIC LEARNING OF PRODUCT MANIPULATION

(71) Applicants: Beijing Jingdong Shangke Information Technology Co., Ltd., Beijing (CN); JD.com American Technologies Corporation, Mountain View, CA (US)

(72) Inventor: Hui Cheng, Mountain View, CA (US)

(21) Appl. No.: 16/137,812

(22) Filed: Sep. 21, 2018

Related U.S. Application Data
(63) Continuation-in-part of application No. 16/137,765, filed on Sep. 21, 2018.

(51) Int. Cl. B25J 9/16

(52) U.S. Cl. CPC B25J 9/163; B25J 9/1697

(57) ABSTRACT

A system for automatic learning of product manipulation, includes multiple scales for determining weight distributions of a product at different locations; multiple sensors for capturing images of the product; a robotic device for manipulating the product; and a computing device in communication with the other components. The computing device is configured to: control the robotic device to manipulate the product with predetermined parameters; determine dimensions and orientation of the product before and after the manipulation; calculate weight distribution of the product; evaluate the parameters; and determine suitable manipulation parameters of the product based on the evaluation.

### CROSS-REFERENCE TO RELATED APPLICATIONS

This application is a continuation-in-part application of the U.S. application Ser. No. 16/137,765, filed on Sep. 21, 2018, entitled “SYSTEM AND METHOD FOR AUTOMATIC PRODUCT ENROLLMENT,” by Hui Cheng, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The invention relates generally to robot technology, and more particularly to a robotic training system that automatically learns how to manipulate a product.

### BACKGROUND OF THE INVENTION

The background description provided herein is for the purpose of generally presenting the context of the invention. Work of the presently named inventors, to the extent it is described in this background section, as well as aspects of the description that may not otherwise qualify as prior art at the time of filing, are neither expressly nor impliedly admitted as prior art against the present invention.

Robotic devices are used more popular in factories, warehouses, research labs, and even in medical surgery. The operations of the robotic devices in those fields include pick and place. When an object is selected, the operation parameters for pick and place need to be set. The parameters may include forces to be used, moving sequences, moving distances, and moving speed. However, when an e-commerce company has various types of products that are different in their characteristics, from those packaged in rigid boxes to those deformable ones, it is hard to set product-specific parameters for those continuously changing products. Further, manually setting parameters for each product cannot meet the need of processing a large number of different products under modern logistic environment.

Therefore, there is a need to address the aforementioned deficiencies and inadequacies in the art.

### SUMMARY OF THE INVENTION

In certain aspects, the present invention relates to a system for automatic learning of product manipulation. In certain embodiments, the system includes: a plurality of scales for a product to be placed thereon, wherein the scales are configured to record weight or weight distribution of the product at different poses and different locations; a plurality of sensors, configured to capture images of the product; at least one robotic device; and at least one computing device in communication with the sensors, the scales, and the robotic device, wherein the computing device is configured to: control the robotic device to manipulate the product with a first set of parameters; determine dimensions, pose and orientation of the product before and after the manipulation with the first set of parameters, using the captured images; calculate weight distribution of the product before and after the manipulation based on the dimensions, the pose, the orientation, and the recorded weights of the product; evaluate the first set of parameters; and determine suitable manipulation parameters of the product based on the evaluation.

In certain embodiments, the sensors comprise at least one of an RGB camera, an RGBD camera, a depth camera, and a laser scanner, and the images comprises visual images and depth images.

In certain embodiments, the system further includes a rig, a learning station, and multiple lights. The visual sensors include multiple RGB cameras and at least one depth camera, the scales are placed at the learning station, the rig is fixed to the learning station and surrounds the scales, and the RGB cameras, the depth camera, and the lights are mounted on the rig. In certain embodiments, the rig has columns fixed to the learning station, and an upper horizontal layer and a lower horizontal layer fixed to the columns and positioned above the scales. The depth camera and one of the RGB camera are mounted at a center of the upper horizontal layer, so as to capture images of top surface of the product; four of the RGB cameras are respectively mounted at four sides of the lower horizontal layer, so as to capture images of side surfaces of the product; and four of the lights are mounted at four corners of the upper horizontal layer. In certain embodiments, the four of the RGB cameras are positioned such that a line linking each of the four of the RGB cameras and a center of a top surface of the scales forms an angle of about 20-70 degrees with the top surface of the scales. In certain embodiments, the angle is about 45 degrees.

In certain embodiments, the computing device is further configured to construct a three-dimensional (3D) model of the product based on the captured visual images.

In certain embodiments, the 3D model includes appearance information of side surfaces of the product. In certain embodiments, the appearance information is colored information.

In certain embodiments, the computing device is further configured to: determine identification of the product; and retrieving product information from a product database based on the identification, where the product information comprises a three-dimensional (3D) model of the product, and the weight distribution of the product. In certain embodiments, the identification of the product is determined from the images of the side surfaces or the appearance information in the 3D model, where the identification may be 1D or 2D barcode, Apriltags, quick response (QR) codes, watermarks, or the like.

In certain embodiments, the product information includes smoothness and hardness of side surfaces of the product.

In certain embodiments, the computing device is further configured to: control the robotic device to manipulate the product with a second set of parameters based on the evaluation of the first set of parameters; determine dimensions and orientation of the product before and after the manipulation using the captured images; calculate weight distribution of the product before and after the manipulation based on the dimensions, the orientation, and the recorded weights of the product; and evaluate the second set of parameters, where the suitable manipulation parameters of the product are determined based on the evaluation of the first set of parameters and the second set of parameters. In certain embodiments, the images include visual images and depth images.

In certain embodiments, the system further includes a plurality of skill set provided by a robot skill set database, wherein the robot skill set database provides the different sets of parameters for the robotic device to manipulate the product, and the suitable manipulation parameters of the product are stored in the robot skill set database.

In certain embodiments, a number of the robotic devices is two, and the two robotic devices are placed at two opposite sides of the scales.

In certain embodiments, the robotic devices comprise a suction device, a robotic arm, a gripper, or an electrical adhesive device.

In certain embodiments, the computing device is configured to perform the step of determine suitable manipulation parameters of the product by machine learning.

In certain aspects, the present invention relates to a method for automatic product manipulation learning. The method includes: recording, by a plurality of scales at different locations, weights of a product placed on the scales; capturing, by a plurality of sensors, images of the product; controlling, by a computing device, at least one robotic device to manipulate the product with a first set of parameters, wherein the computing device is in communication with the sensors, the scales, and the robotic device; determining, by the computing device, dimensions and orientation of the product before and after the manipulation, using the captured images; calculating, by the computing device, weight distribution of the product before and after the manipulation based on the dimensions, the orientation, and the recorded weights of the product; evaluating, by the computing device, the first set of parameters; and determining, by the computing device, suitable manipulation parameters of the product based on the evaluation. In certain embodiments, the sensors include visual cameras and depth cameras, and the captured images include visual images and depth images.

In certain embodiments, the method further includes: controlling the robotic device to manipulate the product with a second set of parameters based on the evaluation of the first set of parameters; determining dimensions and orientation of the product using the captured images, before and after the manipulation with the second set of parameters; calculating weight distribution of the product based on the dimensions, the orientation, and the recorded weights of the product, before and after the manipulation with the second set of parameters; and evaluating the second set of parameters, where the suitable manipulation parameters of the product are determined based on the evaluation of the first set of parameters and the second set of parameters.

In certain embodiments, the computing device is configured to perform the step of determining suitable manipulation parameters of the product by machine learning.

In certain embodiments, the method further includes: constructing a 3D model of the product based on the images. In certain embodiments, the 3D model includes appearance information of side surfaces of the product

In certain aspects, the present invention relates to a non-transitory computer readable medium storing computer executable code, wherein the computer executable code, when executed at a processor of the computing device, is configured to: control a plurality of scales at different locations to record weights of a product placed on the scales; control a plurality of visual sensors to capture visual images of the product; control at least one robotic device to manipulate the product with a first set of parameters; determine dimensions and orientation of the product before and after the manipulation, using the captured visual images; calculate weight distribution of the product before and after the manipulation based on the dimensions, the orientation, and the recorded weights of the product; evaluate the first set of parameters; and determine suitable manipulation parameters of the product based on the evaluation.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic view of an automatic learning system for learning manipulation parameter for a robotic device to manipulate a product, according to certain embodiments of the present invention.

FIG. 2 is a schematic view of a part of the automatic learning system of FIG. 1.

FIGS. 3A and 3B are schematic views of scales in the automatic learning system according to certain embodiments of the present invention.

FIG. 4 is a schematic view of measuring weight distribution of a product according to certain embodiments of the present invention.

FIG. 5 is a schematic view of a manipulation learning application according to certain embodiments of the present invention.

FIG. 6 is a schematic view of automatic learning for product manipulation according to certain embodiments of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As described above, an e-commerce company has various types of products that are different in their characteristics. In certain aspects, for automated manipulation of these products, the present invention provides a system and a method for automatic learning to obtain suitable robot manipulation parameters of the products. In certain embodiments, the manipulation includes how to handle a product properly. The handling operations may include, among other things, where to touch, how strong a force to apply, how fast the robotic device can move while holding the product, and whether or not multiple robotic manipulators are needed. Using the automatic learning system and method, the present invention provides product-specific manipulation parameters/instructions in an effective and efficient way, so that the robotic device is enabled to perform tasks such as picking up a product from a bin, stacking or packaging the product based on the manipulation parameters. In certain embodiments, the automatic learning system and method provide operations specific for a targeted objective toward the product, where the specific operation is not exist in a robotic device manual. Because the operations of the robotic device can be learned automatically, the system and method provide a scalable way to enroll product-specific manipulation for millions of products, improve accuracy and effectiveness in optimizing manipulation parameters, and reduce manual labor cost.

The description will be made as to the embodiments of the present invention in conjunction with the accompanying drawings. In accordance with the purposes of this invention, as embodied and broadly described herein, this invention, in certain aspects, relates to a system and a method for automatic learning of product-specific manipulation parameters.

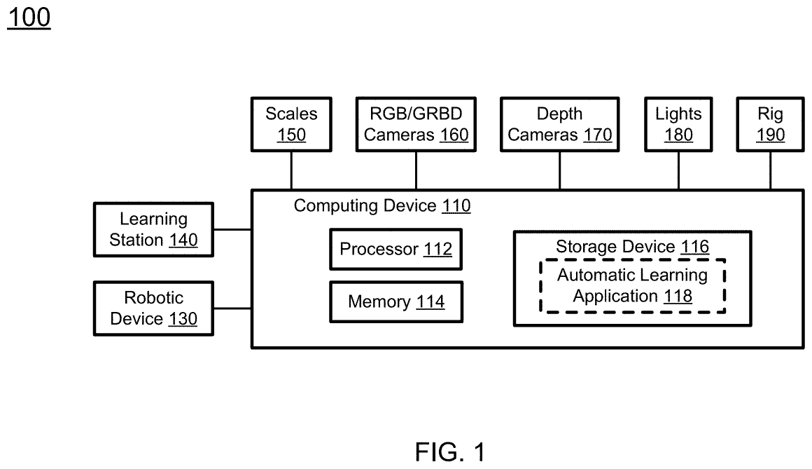

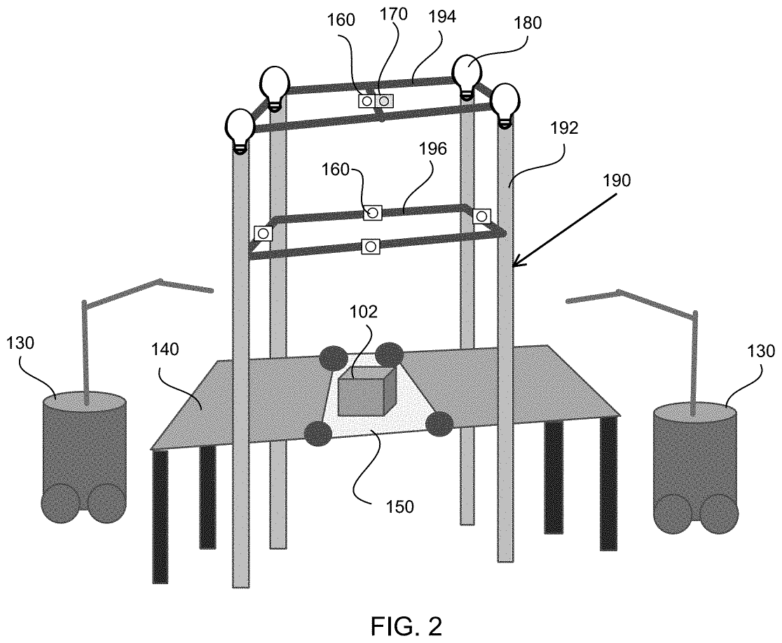

FIGS. 1 and 2 are schematic views of an automatic learning system for product manipulation according to certain embodiments of the present invention. As shown in FIGS. 1 and 2, a product manipulation learning system 100 includes computing device 110, one or more robotic devices 130, a learning station 140, a plurality of scales 150, RGB or RGB cameras 160, depth cameras 170, lights 180, and a rig 190. The computing device 110 is in communication with the robotic device 130, the scales 150, the RGB or RGB cameras 160, and the depth cameras 170, the lights 180, and the rig 190. The scales 150 are placed on or is a part of the learning station 140, the rig 190 is fixed to the learning station 140, and the RGB or RGB cameras 160, the depth cameras 170, and the lights 180 are mounted on the rig 190.

The robotic device 130 is configured to manipulate a product 102. In certain embodiments, the robotic device 130 is controlled by the computing device 110. In other embodiments, the robotic deice 130 may also be an independent, self-controlled robotic device, or controlled by a controller other than the computing device 110. The robotic device 130 may be in any form, such as a suction cup, a robotic arm, a gripper, or an electrical adhesive device. When receiving an instruction and a set of manipulation parameters from the computing device 110, the robotic device 130 manipulate the product 102 accordingly. The robotic device 130 has sensors to obtain toque, force if the robotic device 130 is a gripper, or air flow and pressure if the robotic device 130 is a suction device. Those obtained information, preferably before, during, and after the manipulation of the product 102, are sent to the computing device 110, to evaluate the effectiveness or how safe the manipulation is.

The learning station 140 is configured for placing the product 102 thereon, such that the robotic device 130 can operate the product 102 on the learning station 140. The learning station 140 may include at least one of a flat stationary surface, a moving surface, and a bin shape, so as to mimic different situations for operating the product 102.

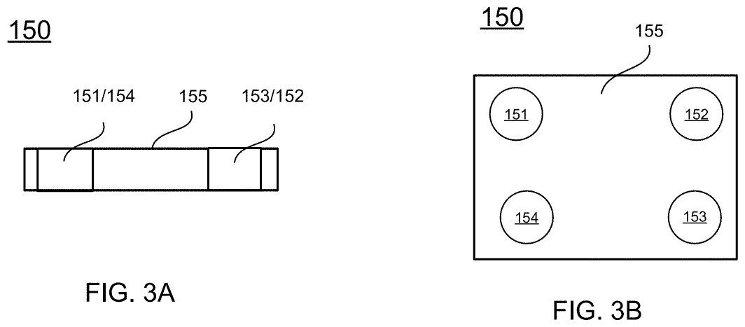

The scales 150 are disposed at the learning station 140, or the scales 150 function as part of the learning station 140. The scales 150 are configured to measure the weights or weight distribution of the product 102 at different locations. FIG. 3A schematically shows a side view of the scales 150, and FIG. 3B schematically shows a top view of the scales 150. As shown in FIGS. 3A and 3B, the scales 150 include a top plate 155 and four scales 151, 152, 153 and 154 disposed under four corners of the top plate 155. In certain embodiments, the top plate 155 is an independent and intact plate covered on the four scales 151. In certain embodiments, the top plate 155 is integrated with the scales, and the top surfaces of the scales 151, 152, 153, and 154 may also be portions of the top surface of the top plate 155. In certain embodiments, the top plate 155 may be made of a transparent material, for example fiber glass. In this embodiment, there are four scales available for measuring weights. In other embodiments, the scales 150 may also include two, three, or more than four scales. In certain embodiment, the scales 150 may include three, five, or more than five scales. In this embodiment, the top plate 155 is in a rectangular shape. In other embodiments, the top plate 155 may be in a square shape, a round shape, and the scales 150 are preferably disposed under the top plate 155 symmetrically.

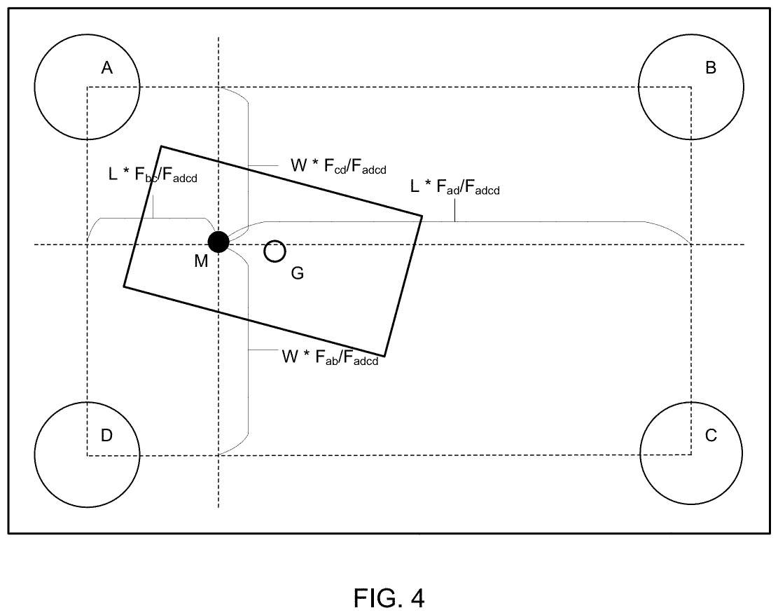

In certain embodiments, the weight distribution calculation is performed as shown in FIG. 4. Specifically, the product 102 is moved onto the top plate 155 of the scales 150. Scales A, B, C and D (or scales 151, 152, 153 and 154) are located under the product 102. The weights measure by the four scales are Fa, Fb, Fc and Fd. The total weights of the four scales are the sum of Fa, Fb, Fc and Fd, and named Fabcd. The sum of Fa and Fb is named Fab, the sum of Fb and Fc is named Fbc, the sum of Fc and Fd is named Fcd, and the sum of Fd and Fa is named Fad. The length of the scales is defined L (between the line connecting the scales A and D and the line connecting scales B and C), and the width of the scale is defined W (between the line connecting the scales A and B and the line connecting the scales C and D). The length of L may be the same, less than, or greater than W, depending on the space required by the scales 150 and the sizes of the products to be weighted. The center of mass of product 102, projected on the top plate 155, along the length direction, is calculated to be in a distance of L×Fbc/Fadcd to the line connecting A and D, or to be in a distance of L×Fad/Fadcd to the line connecting B and C. The center of mass of product 102, projected on the top plate, along the width direction, is calculated to be in a distance of W×Fcd/Fadcd to the line connecting A and B, or to be in a distance of W×Fab/Fadcd to the line connecting C and D. Accordingly, the center of mass of the product 102 projected on the top plate 155 (shown by a solid circle M) is calculated. In comparison, the geometrical center of the product 102 is calculated through the 3D model of the product 102. The geometrical center projected on the top plate 155 is shown as empty circle G. In certain embodiments, the arrangement of the product 102 standing on the current bottom surface is a main position for manipulation, and the center of mass of the product 102 in 3D is estimated by extending the point M upward half of the height H of the product 102. In certain embodiments, the product 102 may also be flipped three times to measure three projections of the center of mass, and estimate the center of mass more accurately using the three projections of the center of mass. In the measurement and calculation of the weight distribution as shown in FIG. 4, the product 102 is placed on the scales 150 and kept stationary for a short period of time such that the readings of the scales 150 are stable for being recorded. In other embodiments, the readings of the scales 150 may be recorded continuously when the product 102 is being manipulated. In other embodiments, the calculation of the weight distribution of the product 102 may include using the recorded weights by the scales 150, the pose of the product 102, the 3D model of the product 102, and optionally the moving speed of the product 102.

The red, green and blue (RGB) or RGB depth (RGBD) cameras 160 are configured to capture color images of the product 102 before, during, and after the manipulation of the product 102 by the robotic device 130. In certain embodiments, the cameras 160 may also be grayscale cameras. The depth cameras 170 are configured to capture depth images of the product 102 before, during, and after the manipulation of the product 102 by the robotic device 130. In certain embodiments, the depth cameras 170 are time-of-flight (ToF) cameras. When RGBD cameras 160 are available, the system 100 may not need to include depth cameras. With the captured color images and depth images, the computing device 110 is able to construct 3D model of the product 102, and have clear views of the appearance of the surfaces of the product 102, such as the top surface and the four side surfaces. In certain embodiments, the RGB cameras 160 and the depth camera 170 are positioned such that at least some of the images cover views of the whole scales 150, part of the edges of the learning station, and/or parts of the rigs, such that those features can be used to locate the position of the product 102 in the image precisely.

In certain embodiments, the system 100 may further include one or more laser scanners. The laser scanner is configured to capture identifications, such as barcode shown in the outer surface of the product 102, and/or other surface features of the product 102. In certain embodiments, the laser scanner is a LIDAR, and the measurement from the LIDAR is used to assist constructing of the 3D model of the product 102.

The lights or light sources 180 are mounted on the rig 190 and configured to provide consistent lighting condition and reduce shadow and glare. In certain embodiments, the lights 180 preferably provide diffused light. In certain embodiments, an opaque box around the rig 190 or replacing the rig 190 is provided to reduce or eliminate the external light sources, such that the environment within the box has a consistent light condition. In certain embodiments, the lights 180 are manually controlled. In certain embodiments, the lights 180 are controlled by a specific controller. In certain embodiments, the lights 180 are controlled by the computing device 110, to turn certain lights 180 on and off, or to adjust intensity and optionally orientation of certain lights 180.

As shown in FIG. 2, the rig 190 has vertical columns 192, an upper layer 194, and a lower layer 196. In certain embodiments, the vertical columns 192 are fixed to the learning station 140. The upper layer 194 and the lower layer 196 are horizontal layers parallel to each other, and the upper layer 194 is higher than the lower layer 196. Both the upper layer 194 and the lower layer 196 are positioned above the top surface of the learning station 140. The rig 190 has a projection on the learning station 140, which could be rectangular. In certain embodiments, the scales 150 are located within the projection of the rig 190, and preferably located at the center of the projection of the rig 190. In certain embodiments, based on the number and arrangement of the RGB cameras 160, the depth cameras 170, and the lights 180, the rig 190 may also have less than or greater than two layers. Further, the number and arrangement of the RGB cameras 160, the depth cameras 170, the lights 180, and the rig 190 are not limited to the description above or the drawings according to certain embodiments of the present invention.

In certain embodiments, the distance between the upper layer 194 and the lower layer 196 and the top surface of the learning station 140 are respectively in a range of 25-500 cm, 10-200 cm. In certain embodiments, the distances from the upper layer 194 and the lower layer 196 to the top surface of the learning station 140 are respectively in a range of 50-200 cm, and 25-100 cm. In certain embodiments, the distances from the upper layer 194 and the lower layer 196 to the top surface of the learning station 140 are respectively about 100 cm and 50 cm. In certain embodiments, the heights of at least one of the upper layer 194 and the lower layer 196 are adjustable. In other words, the two layers can be moved up and down along the columns 192, such that the system is usable for different sizes of product 102. In certain embodiments, the height adjustment of the layers is controlled by the computing device 110 automatically based on the size of the product 102.

The RGB cameras 160, the depth cameras 170, and the light 180 are mounted on the two layers 194 and 196, or the columns 192 of the rig 190. As shown in FIG. 2, one RGB camera 160 is placed in the center of the upper layer 194, and four RGB cameras 160 are respectively placed at the centers of four sides of the lower layer 196. The depth camera 170 is placed at the center of the upper layer 194, that is, one RGB camera 160 and the depth camera 170 are placed next to each other in the center of the upper layer 194. There are four lights 180, and the four lights 180 are placed at four corners of the upper layer 194. In certain embodiments, the upper layer 194 and the lower layer 196 may be combined as one layer, as long as there is enough space to arrange the RGB cameras 160, the depth camera 170, and the lights 180. In certain embodiments, the structure of the rig 190, and the arrangement of the RGB cameras 160, the depth cameras 170 and the lights 180 may vary depending on their respective characteristics.

In certain embodiments, the product 102 has a shape of a cuboid box. As shown in FIG. 2, when the product 102 is placed substantially at the center of the learning station 140 (or in other words or preferably, at the center of the scales 150), the RGB camera 160 at the upper layer 194 is positioned to capture images of the top surface of the product 102 clearly, and the four RGB cameras 160 at the lower layer 196 are positioned to capture images of the sides surfaces of the product 102 clearly. In certain embodiments, the four RGB cameras 160 in the lower layer 196 are positioned such that a line linking the camera and the geometric center of the scales 150 forms an angle of about 20-80 degrees with the top surface of the learning station 140. In certain embodiments, the angle is about 30-70 degrees. In certain embodiments, the angle is about 40-60 degrees. In one embodiment, the angle is about 45 degrees. The design of the angle and the dimension of the rig 190 make the cameras 160 take side surface images of the product 102 clearly, without bumping into the product 102 or the robotic devices 130 when the product 102 is moved onto the learning station 140 or is manipulated on the learning station 140.

The computing device 110 may be a server computer, a cluster, a general-purpose computer, a specialized computer, a tablet, a smart phone, or a cloud-based device. In certain embodiments, the computing device 110 is a server computer to store and processing information collected from the robotic device 130, the scales 150, the RGB cameras 160, the depth cameras 170, and optionally the lights 180 and the rig 190. As shown in FIG. 1, the computing device 110 may include, without being limited to, a processor 112, a memory 114, and a storage device 116. In certain embodiments, the computing device 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices.

The processor 112 controls operation of the computing device 110. In certain embodiments, the processor 112 may be a central processing unit (CPU). The processor 112 can execute an operating system (OS) or other applications of the computing device 110. In some embodiments, the computing device 110 may have more than one CPU as the processor, such as two CPUs, four CPUs, eight CPUs, or any suitable number of CPUs.

The memory 114 can be a volatile memory, such as the random-access memory (RAM), for storing the data and information during the operation of the computing device 110. In certain embodiments, the memory 114 may be a volatile memory array. In certain embodiments, the computing device 110 may run on more than one memory 114.

The storage device 116 is a non-volatile data storage media or device for storing the OS (not shown) and other applications of the computing device 110. Examples of the storage device 116 may include flash memory, memory cards, USB drives, hard drives, floppy disks, optical drives, or any other types of data storage devices. In certain embodiments, the computing device 110 may have multiple storage devices 116, which may be identical storage devices or different types of storage devices, and the applications of the computing device 110 may be stored in one or more of the storage device 116 of the computing device 110. The storage device 116 includes a manipulation learning application 118, which when being executed, learns how to manipulate the product 102 automatically. Specifically, the manipulation learning application 118 is configured to manipulate the product 102 according to certain parameters, adjust the manipulating parameters based on the RGB images, the depth images and the weight distribution, and determine suitable manipulation parameters of the product 102.

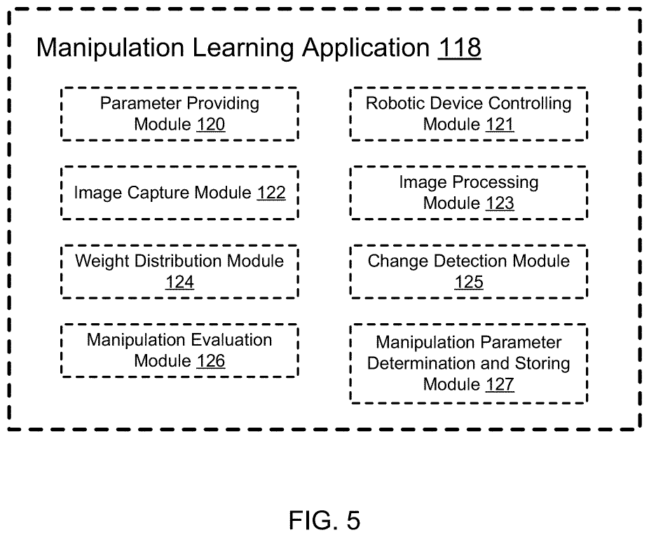

FIG. 5 schematically depicts the structure of the automatic manipulation learning application 118 according to certain embodiments of the present invention. As shown in FIG. 5, the manipulation learning application 118 may include, among other things, a parameter providing module 120, a robotic device controlling module 121, an image capture module 122, an image processing module 123, a weight distribution module 124, a change detection module 125, a manipulation evaluation module 126, and a manipulation parameter determination and storing module 127.

The parameter providing module 120 is configured to, in response to receiving a goal of manipulation, provide manipulation parameters for manipulate the product 102 corresponding to the goal of manipulation. In certain embodiments, the manipulation parameters and the corresponding goals are retrieved from a robot skill set database. The robot skill set database may be stored in the storage device 116 of the computing device 110, or storage device of other server computers or clouds. The goal of manipulation may be received from a user, or determined by the computing device 100 based on the images of the product 102. The goal of manipulation may include, among other things, picking up the product 102 from a bin, moving the product 102 along a straight line, flipping the product 102, and stacking the product 102 on another product.

The robotic device controlling module 121 is configured to, in response to receiving provided manipulation parameters, control the manipulation of the robotic devices 130 according to the parameters. In certain embodiments, the robotic devices 130 are in communication with the computing device 110, and may independently manipulate the product 102 based on the parameters received from the robotic device controlling module 121. In other embodiments, the robotic device controlling module 121 may also take over the control of the robotic devices 130, and directly instruct the manipulations of the robotic devices 130.

The image capture module 122 is configured to, before, during and after the manipulation of the robotic device 130, control the RGB or RGBD cameras 160 and the depth cameras 170 to capture images. In certain embodiments, the image capture module 122 may be further configured to, when a laser scanner is used, control the laser scanner to scan the product 102, for example, to retrieve a barcode. In certain embodiments, the image capture module 122 may also passively receive images captured by the RGB/RGBD cameras 160 and the depth cameras 170. After obtaining the images, the image capture module 122 sends the images to the image processing module 123.

The image processing module 123, after obtaining the images from the image capture module 122, is configured to process the captured images of the product 102. The processing of the images may include at least one of synchronizing the RGB images and the depth images, adjusting light balance of the images, reformatting and resizing the images, extracting identification of the product 102, detecting the product 102 from the images, segmenting the images and constructing the 3D model of the product 102, and determining poses of the product 102. When the identification of the product 102, such as an 1D/2D barcode, an Apriltag, or a QR code, is extracted, the image processing module 123 is further configured to retrieve product information from a product information database based on the identification. In certain embodiments, the product information database is located at the storage device 116. In certain embodiments, the product information database may also be stored in any other server computers or cloud computers. The retrieved product information may include dimensions of the product 102, 3D model of the product 102, and weight distribution of the product 102. When the product information is retrieved, the image processing module 123 doesn't have to determine or calculate the product information that is already available, which reduces cost and improves efficiency of the system 100. For example, when the 3D model of the product 102 is available, the image processing module 123 only need to match or link the captured images to the 3D model 102, and doesn't need to reconstruct the 3D model from those captured images. In other embodiments, even when the 3D model of the product 102 can be retrieved, the reconstruction or monitoring of the 3D model before, during, and after the manipulation is required, so as to monitor the change of the product 102 regarding the 3D model. However, the availability of the retrieved 3D model may make the process easier, where an initial reconstruction of the 3D model from the captured images may not be necessary, and the image processing module 123 is configured to track the change of the 3D model based on the registration correspondence between the captured images and the 3D module, and optionally update the 3D model continuously.

The weight distribution module 124 is configured to control the scales 150 at different locations to measure the weights of the product 102, and calculate the weight distribution of the product 102. Because the calculation of the weight distribution may require the 3D model and the pose of the product 102 in addition to the measured weights by the scales 150, the weight distribution module 124 is further configured to communicate with the image processing module 124 to obtain the information. The weight distribution module 124 may calculate the weight distribution using the method as shown in FIG. 4 based on the manipulation, the 3D model, and the pose of the product 102.

The change detection module 125 is configured to monitor the changes of the product 102 before, during, and after the manipulation. In certain embodiments, the detection of the changes is based on the 3D model, the pose, and the weight distribution of the product 102 before, during, and after the manipulation. The changes detected may include, among other things, the appearance change of the product 102, such as the scratch of the barcode of the product 102, and the 3D model change of the product 102, such as the dent or depressed corners or edges. It can be inferred from the information whether the product 102 has been damaged during the manipulation.

The manipulation evaluation module 126 is configured to evaluate the efficiency and safety of the manipulation. The evaluation is based on the features collected by the robotic device 130 during the manipulation of the product 102. In certain embodiments, the robotic device 130 is equipped with a variety of sensors to collect torque and force from a gripper, or air flow and pressure from a suction device, and the change of the collected features can be used to evaluate the efficiency and safety of the manipulation. For example, when the product 102 is moved from one place to another, the change of air flow of the suction cup or the change of the force of the gripper indicates that the product is not secured very well during the movement. Under this situation, the manipulation parameters, such as the suction force or the gripper force, may need to be increased.

The manipulation parameter determination and storing module 127 is configured to, when the manipulation parameters cause obvious damage to the product 102, or don't provide effective and safe manipulation to the product, adjust the parameters, run the manipulation again using the adjusted parameters, and evaluate the manipulation. The manipulation parameter determination and storing module 127 is further configured to, when the manipulation parameters don't cause obvious damage to the product, and provide effective and safe manipulation to the product, store the parameters as a good product-specific manipulation strategy in a database, such that when manipulation of the product 102 is needed, a robotic device can retrieve those parameters for manipulation. In certain embodiments, the evaluation has a threshold, and the parameters are determined to be suitable for manipulation when the changes don't exceed a predetermined level. For example, when the change of air flow of the suction cup doesn't exceed a predetermined number, such as 10%, during the moving of the product 102, the computing device 110 determines that the safety of the manipulation is good.

In certain embodiments, the system 100 further includes a product database storing information of the product 102, such as barcode, dimensions, 3D model, weight distribution, and material of the product 102.

In certain embodiments, the system 100 further includes a product-specific manipulation strategy database, which stores the manipulation strategy learned through the performance of the system 100.

In certain embodiments, the system 100 further includes a robot skill set goals and use cases database. The database includes goals of manipulating the product 102, such as moving a product along a straight line, picking up a product from a bin, flipping a product, etc., and the use cases store manipulation parameters corresponding to each of the goals. In certain embodiments, the parameters can be retrieved based on the set goals of a specific product, and the retrieved parameters can be used as initial parameters for manipulation. The system 100 then evaluate the effect of using those initial parameters, and adjusting the parameters when the manipulation effect is not ideal.

In certain embodiments, the computing device 110 is a server computer, and the above databases are part of the storage device 116. In certain embodiments, at least one of the above databases may also be stored in storage device separated or remote from the computing device 110. In certain embodiments, at least one of the above databases is stored in a cloud.

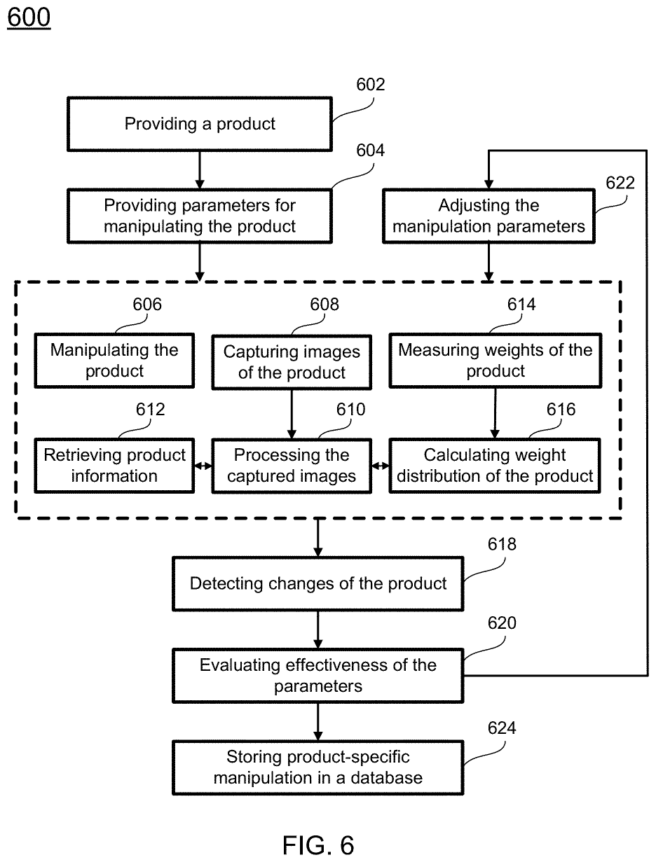

FIG. 6 schematically shows a method for automatic product manipulation learning according to certain embodiments of the present invention. In certain embodiments, the method as shown in FIG. 6 may be implemented on an automatic product manipulation learning system as shown in FIG. 1. It should be particularly noted that, unless otherwise stated in the present invention, the steps of the method may be arranged in a different sequential order, and are thus not limited to the sequential order as shown in FIG. 6.

As shown in FIG. 6, at procedure 602, a product 102 is provided. In certain embodiments, the computing device 110 instructs the robotic device 130 to pick up the product 102 and place the product 102 on the learning station 140. The product 102 may be placed at the center of the learning station 140. In certain embodiments, the product 102 may be placed on the learning station 140 by other means instead of the robotic device 130. In certain embodiments, because the product 102 is provided by other means, there is no need for the computing deice 110 to instruct the robotic deice 130 to place the product 102. In other words, the product 102 may be placed on the learning station 140 first, and then the system 100 take over the rest of the procedures of learning how to manipulate the product 102 optimally.

After the product 102 is placed on the learning station 140, at procedure 604, the computing device 110 receives a goal of manipulation, and in response to receiving the goal, providing a set of parameters to the robotic device 130 for manipulating the product 102. In certain embodiments, the computing device 110 has a user interface, which provides a list of goals of manipulation for selection, and a user can select one of the goals of manipulation from the list. In certain embodiments, the goal of manipulation may be entered by the user directly without the need of selection. In certain embodiments, the computing device 110 may take several images of the product 102, and determine a manipulation goal based on the size and shape of the product 102. The goal of manipulation may include, among other things, picking up the product 102 from a bin, moving the product 102 along a straight line, flipping the product 102, and stacking the product 102 on another product.

Upon receiving the parameters from the computing device 110, at procedure 606, the robotic devices 130 perform the manipulation of the product 102, such as picking up the product 102, moving the product 102, flipping the product 102, or stacking the product 102. In certain embodiments, the robotic devices 130 are controlled by the robotic device controlling module 121. In other embodiments, the robotic devices 130 are in communication with the computing device 110, and manipulate the product 102 independently based on the parameters received from the computing device 110.

Before, during, and after the manipulation of the product 102 by the computing device 130 at procedure 606, at procedure 608, the image capture module 121 controls the RGB cameras 160 and the depth cameras 170 to capture images of the product 102. The captured images include color images and depth images. In certain embodiments, when the system 100 includes grayscale cameras instead of the RGB cameras 160, the captured images may also be grayscale images and depth images. In certain embodiments, when only RGBD cameras are available instead of both RGB(D) cameras and depth cameras, the captured images may be colored RGBD images. In certain embodiments, the RGB cameras 160 and the depth cameras 170 are in communication with the image capture module 124, but the cameras 160 and 170 are independently controlled and are configured to send the captured images to the computing device 110.

After capturing images, at procedure 610, the image processing module 123 processes those images. The processing of the captured images includes at least one of synchronizing the RGB images and the depth images, adjusting light balance of the images, reformatting and resizing the images, extracting identification of the product 102, detecting the product 102 from the images, segmenting the images, constructing 3D model of the product 102, and determining poses of the product 102.

Further, at procedure 612, the image processing module 123 may retrieve product information from the product information database based on the identification of the product 102. The product information may include dimensions of the product 102, 3D model of the product 102, and weight distribution of the product 102. When the product information includes 3D model of the product 102, the procedure 610 may not need to construct the 3D model of the product 102 based on the captured images. Under this situation, the image processing module 123 only needs to match or link the captured images to the 3D model retrieved from the product information database. In other embodiments, both the retrieved 3D model and the reconstructed 3D model from the captured images are needed, so as to determine the changes of the product 102 in regard to the 3D model.

Before, during, and after the manipulation of the product 102 by the computing device 130 at procedure 606, at procedure 614, the weight distribution module 124 controls the scales 150 to measure the weights of the product 102.

Then at procedure 616, the weight distribution module 124 calculates the weight distribution of the product 102. In certain embodiments, as shown in FIG. 4, the position of the product 102 is used for calculating the weight distribution of the product 102. Because the calculation of the weight distribution of the product 102 uses the 3D model and the pose of the product 102, the weight distribution module 124 communicates with the image processing module 124 to obtain the information. The weight distribution module 124 then based on the 3D model, the pose, and the recorded weights of the product 102, to accurately calculate the weight distribution of the product 102.

With the 3D model, the pose, and the weight distribution before, during and after the manipulation of the product 102, at procedure 618, the change detection module 125 detects the changes of the product 102. The changes detected may include, among other things, the appearance change of the product 102, such as the scratch of the barcode of the product 102, and the 3D model change of the product 102, such as the dent or depressed corners or edges. The information is useful for determining whether the product 102 has been damaged during the process. The manipulation parameters may then be adjusted based on the detected changes. For example, if dent of the product is observed during the manipulation, the suction force or grip force by the robotic device 130 should be decreased to avoid damage to the product 102.

Before, after, or at the same time of the procedure 618, at procedure 620, the manipulation evaluation module 126 evaluates the efficiency and safety of the manipulation. The evaluation is based on the features collected by the robotic device 130 during the manipulation of the product 102. In certain embodiments, the robotic device 130 is equipped with a variety of sensors to collect the torque and/or the force from gripper, air flow and pressure from the suction devices, and the change of the collected features can be used to evaluate the efficiency and safety of the manipulation. For example, when a product is being moved from one place to another, the change of air flow of a suction cup or the change of force of a gripper indicates that the product is not secured very well during the movement. Under this situation, the manipulation parameters, such as the suction force or the gripper force, may need to be increased.

When the manipulation parameters cause obvious damage to the product, or don't provide effective and safe manipulation to the product, at procedure 622, the computing device 130 adjusts the parameters, runs the manipulation again using the adjusted parameters, and evaluate the manipulation. That is, run the procedures 606-620 for another time.

When the manipulation parameters don't cause obvious damage to the product, and provide effective and safe manipulation to the product, at procedure 624, the computing device 130 regards the parameters as a good product-specific manipulation strategy, and stores the manipulation strategy in a database, such that when manipulation of the product 102 is needed, a robotic device can retrieve those parameters for manipulation.

In certain aspects, the present invention relates to a non-transitory computer readable medium storing computer executable code. In certain embodiments, the computer executable code may be the software stored in the storage device 116 as described above. The computer executable code, when being executed, may perform one of the methods described above. In certain embodiments, the non-transitory computer readable medium may include, but not limited to, the storage device 116 of the computing device 110 as described above, or any other storage media of the computing device 110.

In summary, certain embodiments of the present invention provide a systematic and automatic method to learn optimal parameters for manipulating a product by a robotic device. Therefore, when a large number of products exist, the system is able to find the best parameters for manipulate the products by a robotic device quickly, such that those obtained parameters can be used when the product is manipulated by other robotic devices. As a result, there is no need to do try and error experiment on the product one by one by a user. Further, the itinerary adjusting of the parameters makes the selection of the optimal parameters accurate.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A system for automatic learning of product manipulation, comprising:
a plurality of scales for a product to be placed thereon, wherein the scales are configured to record weights of the product at different locations;
a plurality of sensors, configured to capture images of the product;
at least one robotic device; and
a computing device in communication with the sensors, the scales, and the robotic device, wherein the computing device is configured to:
control the robotic device to manipulate the product with a first set of parameters;
determine dimensions and orientation of the product before and after the manipulation with the first set of parameters, using the captured images;
calculate weight distribution of the product before and after the manipulation based on the dimensions, the orientation, and the recorded weights of the product;
evaluate the first set of parameters; and
determine suitable manipulation parameters of the product based on the evaluation.

2. The system of claim 1, wherein the weight distribution of the product is a center of mass of the product.

3. The system of claim 1, wherein the sensors comprise at least one of an RGB camera, an RGBD camera, a depth camera, and a laser scanner, and the images comprises visual images and depth images.

4. The system of claim 1, further comprising a rig, a learning station, and a plurality of lights, wherein the sensors comprise a plurality of RGB cameras and at least one depth camera, the scales are placed at the learning station, the rig is fixed to the learning station and surrounds the scales, and the RGB cameras, the depth camera, and the lights are mounted on the rig.

5. The system of claim 4, wherein the rig comprises columns fixed to the learning station, and an upper horizontal layer and a lower horizontal layer fixed to the columns and positioned above the scales, wherein the depth camera and one of the RGB cameras are mounted at a center of the upper horizontal layer, so as to capture images of top surface of the product, four of the RGB cameras are respectively mounted at four sides of the lower horizontal layer, so as to capture images of side surfaces of the product, and four of the lights are mounted at four corners of the upper horizontal layer.

6. The system of claim 5, wherein the four of the RGB cameras are positioned such that a line linking each of the four of the RGB cameras and a center of a top surface of the scales forms an angle of about 20-70 degrees with the top surface of the scales.

7. The system of claim 1, wherein the computing device is further configured to construct a three-dimensional (3D) model of the product based on the captured images.

8. The system of claim 7, wherein the 3D model comprises appearance information of side surfaces of the product.

9. The system of claim 1, wherein the computing device is further configured to:
determine identification of the product; and
retrieving product information from a product database based on the identification,
wherein the product information comprises a three-dimensional (3D) model of the product, and the weight distribution of the product.

10. The system of claim 9, wherein the product information comprises smoothness and hardness of side surfaces of the product.

11. The system of claim 1, wherein the computing device is further configured to:
control the robotic device to manipulate the product with a second set of parameters based on the evaluation of the first set of parameters;
determine dimensions and orientation of the product before and after the manipulation using the captured images;
calculate weight distribution of the product before and after the manipulation based on the dimensions, the orientation, and the recorded weights of the product; and
evaluate the second set of parameters,
wherein the suitable manipulation parameters of the product are determined based on the evaluation of the first set of parameters and the second set of parameters.

12. The system of claim 1, further comprising a plurality of skill set provided by a robot skill set database, wherein the robot skill set database provides parameters for the robotic device to manipulate the product, and the suitable manipulation parameters of the product are stored in the robot skill database.

13. The system of claim 1, wherein a number of the robotic devices is two, and the two robotic devices are placed at two opposite sides of the scales.

14. The system of claim 1, wherein the robotic devices comprise a suction device, a robotic arm, a gripper, or an electrical adhesive device.

15. The system of claim 1, wherein the computing device is configured to perform the step of determine suitable manipulation parameters of the product by machine learning.

16. A method for automatic product manipulation learning, comprising:
recording, by a plurality of scales at different locations, weights of a product placed on the scales;
capturing, by a plurality of sensors, images of the product;
controlling, by a computing device, at least one robotic device to manipulate the product with a first set of parameters, wherein the computing device is in communication with the sensors, the scales, and the robotic device;
determining, by the computing device, dimensions and orientation of the product before and after the manipulation, using the captured images;
calculating, by the computing device, weight distribution of the product before and after the manipulation based on the dimensions, the orientation, and the recorded weights of the product;
evaluating, by the computing device, the first set of parameters; and
determining, by the computing device, suitable manipulation parameters of the product based on the evaluation.

17. The method of claim 16, further comprising:
controlling the robotic device to manipulate the product with a second set of parameters based on the evaluation of the first set of parameters;
determining dimensions and orientation of the product using the captured images, before and after the manipulation with the second set of parameters;
calculating weight distribution of the product based on the dimensions, the orientation, and the recorded weights of the product, before and after the manipulation with the second set of parameters; and
evaluating the second set of parameters,
wherein the suitable manipulation parameters of the product are determined based on the evaluation of the first set of parameters and the second set of parameters.

18. The method of claim 16, wherein the computing device is configured to perform the step of determining suitable manipulation parameters of the product by machine learning.

19. The method of claim 16, further comprising: constructing a 3D model of the product based on the images, wherein the 3D model comprises appearance information of side surfaces of the product.

20. A non-transitory computer readable medium storing computer executable code, wherein the computer executable code, when executed at a processor of the computing device, is configured to:
control a plurality of scales at different locations to record weights of a product placed on the scales;
control a plurality of sensors to capture images of the product;
control at least one robotic device to manipulate the product with a first set of parameters;
determine dimensions and orientation of the product before and after the manipulation, using the captured images;
calculate weight distribution of the product before and after the manipulation based on the dimensions, the orientation, and the recorded weights of the product;
evaluate the first set of parameters; and
determine suitable manipulation parameters of the product based on the evaluation.
